(19) United States
(12) Patent Application Publication
(10) Pub. No.: US 2004/0224226 A1
(43) Pub. Date: Nov. 11, 2004

(54) Electrochemical cell and production method therefor

(76) Inventors: Morinobu Endo, Suzaka-shi (JP); Tetsuo Uchiyama, Tokyo (JP); Kazutoshi Takeda, Miyagi (JP); Yoshifumi Maehara, Chiba-shi (JP); Masato Takenaka, Chiba-shi (JP); Tsugio Sakai, Miyagi (JP); Kensuke Tahara, Miyagi (JP); Shinichi Takasugi, Miyagi (JP); Masashi Yamada, Miyagi (JP); Syuichi Aizu, Miyagi (JP)

Correspondence Address: ADAMS & WILKS, 31st FLOOR, 50 BROADWAY, NEW YORK, NY, 10004, US

(21) Appl. No.: 10/803,777

(22) Filed: Mar. 18, 2004

(30) Foreign Application Priority Data
Apr. 11, 2003 (JP) 2003-107296
Apr. 11, 2003 (JP) 2003-107297

(51) Int. Cl. H01M 2/08; H01M 10/04

(52) U.S. Cl. 429/184; 29/623.2; 29/623.4

(57) ABSTRACT

By enhancing a sealing property of an electrochemical cell, enhancement of its long-term reliability is attempted. In the electrochemical cell in which a power generation element is sealed by an outer packaging laminated film, a sealing material is melt-bonded in an entire periphery of a predetermined portion of an outer lead terminal.

### BACKGROUND OF THE INVENTION

1. Field of the Invention

The present invention relates to an electrochemical cell in which a power generation element such as a capacitor or a cell is sealed by an external packaging laminated film and a production method therefor, more particularly, to an electrochemical cell which is excellent in a sealing property at an outer lead terminal.

2. Description of the Related Arts

With developments of electronic appliances in recent years, a thin high-performance cell such as a non-aqueous electrolyte secondary cell which is small in size, light in weight, has a high energy density and can repeat charge and discharge of electricity has been expected.

A constitution in which a power generation element comprising a negative electrode of lithium and a positive electrode of butylpyridinium iodide is inserted in a thermally melt-bondable resin tube, subjected to an acid treatment, degreased and, then, thermally melt-bonded with a lead wire covered with a thermally melt-bondable resin of same quality as that of this tube to seal the cell is known (refer to, for example, Patent Document 1). On this occasion, the thermally melt-bondable tube is made of an iodine-resistant fluororesin, such as a tetrafluoroethylene-hexafluoropropylene copolymer resin, a polytrifluorochloroethylenee resin, a tetrafluoroethylene-ethylene copolymer resin, a polyfluoroalkoxylate resin, or a polyfluorovinylidene resin. A melting point of the iodine-resistant fluororesin is as high as from 170° C. to 310° C. A method for covering the lead wire with the thermally melt-bondable resin is performed such that a surface of the lead wire is lightly treated with an acid, degreased by trichloroethylene and, then, the resultant lead wire is inserted between thermally melt-bondable resin sheets and, thereafter, heated under pressure for about 10 minutes at a temperature of a melting point of the resin.

Further, a non-aqueous electrolyte cell having a constitution in which a positive electrode, a negative electrode and an electrolytic solution are sealed in a sealing bag, respective lead wires of the positive and negative electrodes are allowed to extend outside and, also, sealing of the electrolytic solution is highly reliable is known (refer to, for example, Patent Document 2). On this occasion, the sealing bag and the lead wires are integrated into a unity by thermally melt-bonding an insulator of the sealing bag with an insulator of an outermost layer of each of the lead wires with each other. The sealing bag is provided with an insulating layer which does not melt at the time of heat-sealing between a metal layer and the insulating layer.

In another case, a cell, having an outer packaging case of a laminated sheet, in which at least a portion of a surface of each of the positive electrode lead wire and negative electrode lead wire that passes through a sealing position of the laminated sheet is covered by a thermally melt-bondable resin having an excellent adhesion property to a metal is known (refer to, for example, Patent Document 3). On this occasion, the thermally melt-bondable resin is at least one polymer selected from the group consisting of: a modified polyethylene, polypropylene, polymethylpentene, or any combinations thereof.

Patent Document 1: JP-A No. 56-71278 (p. 2; FIG. 1);

Patent Document 2: JP-A No. 9-283100 (pp. 2 to 3; FIG. 3); and

Patent Document 3: JP-A No. 11-233133 (pp. 2 to 4; FIG. 1).

Since the cell as described in Patent Document 1 uses the iodine-resistant fluororesin, such as the tetrafluoroethylene-hexafluoropropylene copolymer resin, the polytrifluorochloroethylene resin, the tetrafluoroethylene-ethylene copolymer resin, the polyfluoroalkoxylate resin, or a polyfluorovinylidene resin in the thermally melt-bondable resin tube, it is difficult to laminate the tube with a metal such as an aluminum foil and, therefore, the tube is not appropriate for a lithium ion secondary cell or a double-layered electric capacitor which abhors permeation of moisture. Since any of these iodine-resistant fluororesins is not modified with acrylic acid, maleic acid or the like, it is dubious that, even when the lead wire is covered with the iodine-resistant fluororesin, it is truly covered up to an interface therebetween. Further, since the melting point of the iodine-resistant fluororesin is as high as from 170° C. to 310° C., it is difficult to thermally melt-bond the tube with the lead wire covered with the thermally melt-bondable resin of same quality as that of the tube without giving adverse effect to the power generation element such as a positive electrode active material, a negative electrode active material, the electrolytic solution or an electrolyte, a separator or the like to thereby seal the cell. Since a surface of the lead wire is only lightly treated by an acid, degreased by using trichloroethylene and not actively subjected to a specific surface treatment for modification, bonding by a van der Waals force does not occur at an interface between the surface of the lead wire and the surface of the thermally melt-bondable resin. Therefore, the surface of the lead wire has a problem that it is not sufficiently covered. Such method as covering the lead wire with the thermally melt-bondable resin is merely to insert the lead wire between the thermally melt-bondable resin sheets and, then, heat the resultant composite under pressure for about 10 minutes at a temperature of a melting point of the resin. Since the composite is not sufficiently heated at a temperature of at least the melting point, the thermally melt-bondable resin, which is an iodine-resistant fluororesin, is not fully fluidized and, therefore, the lead wire is not covered up to the interface between the lead wire and the resin. As described above, in the conventional cell, since the sealing property on the surface on the side of the lead wire is not sufficient, moisture, air or the like is infiltrated, or a content is leaked outside, thereby deteriorating reliability of the cell.

In the cell as described in Patent Document 2 only discloses that an insulator is provided to a lead wire. Namely, there is no description at all on a constitution and a material of the insulator, a method for proving the insulator to the lead wire and a temperature at the time of such provision, presence or absence of any surface modification treatment of the lead wire, a sealing property at a level of an interface between the lead wire and the insulator and the like. As described above, in a conventional cell, since the sealing property on the surface on the side of the lead wire is not sufficient, moisture, air or the like is infiltrated, or a content is leaked outside, thereby deteriorating reliability of the cell.

In a cell as described in Patent Document 3, a positive electrode lead or a negative electrode lead are sandwiched by two sheets of the modified polyethylene film to be a laminate and, then, the laminate is held under a pressure of 1 Kgf/cm² for 30 seconds at 200° C. to be in a state of being covered with film at a position at which each lead passes through a sealing portion. However, it is questionable that the two sheets of the modified polyethylene film go around a side face of the positive electrode lead or the negative electrode lead and, then, completely wrap an interface between the side face of the positive electrode lead or negative electrode lead and the modified polyethylene film. The conventional cell has a defect in that a sealing property on a side face portion of the positive electrode lead or negative electrode lead is deteriorated. It is described that the melt-bondable resin is constituted by a polymer selected from the group consisting of: a modified polyethylene, polypropylene, and polymethylpentene, or any combinations thereof; however, it is not described at all that such selection of a melt-bondable resin material is deeply related with a laminate constitution. In regard to a constitution of the melt-bondable resin, there is no description on a three-layered product in which polymethylpentene (melting point: from 230° C. to 240° C.), or polyethylene naphthalate (melting point: from 260° C. to 270° C.) is provided at least in the center and the modified polyethylene or the modified polypropylene is provided on both sides thereof. In the constitution of the melt-bondable resin of the conventional cell, since a material having a high melting point is not provided at least in the center, there may sometimes cause a phenomenon in which the positive electrode lead or the negative electrode lead and a metal sheet in the laminated sheet are allowed to contact with each other and, then, the positive electrode lead and the negative electrode lead may form a short-circuit therebetween via the metal sheet.

### SUMMARY OF THE INVENTION

In order to solve these problems, according to the present invention, in an electrochemical cell in which a power generation element is sealed by an outer packaging laminated film, a sealing material is melt-bonded in an entire periphery of a predetermined portion of an outer lead terminal. By taking such constitution as described above, leakage of an inner electrolytic solution from an outer lead terminal, specifically, a side face of the outer lead terminal, and infiltration of moisture and air from outside the electrochemical cell are prevented and, therefore, the electrochemical cell can maintain a long-term sealing property, thereby advantageously maintaining performance.

Further, according to the invention, in the electrochemical cell in which a power generation element is sealed by an outer packaging laminated film, a sealing material is melt-bonded to an outer lead terminal and the sealing material goes around a side face of the outer lead terminal at a temperature of at least a melting point of the sealing material. By taking such constitution as described above, leakage of an inner electrolytic solution from an outer lead terminal, specifically, a side face of the outer lead terminal, and infiltration of moisture and air from outside the electrochemical cell are prevented and, therefore, the electrochemical cell can maintain a long-term sealing property, thereby advantageously maintaining performance.

Still further, there is provided a method for producing an electrochemical cell in which a power generation element is sealed by an outer packaging laminated film according to the invention comprises the steps of:

melt-bonding the sealing material in an entire periphery of a predetermined portion of an outer lead terminal; and

heat-sealing at least one portion of a sealing material covering portion of the outer lead terminal together with the outer packaging laminated film. By performing such method as described above, the electrochemical cell in which leakage of an inner electrolytic solution from an outer lead terminal, specifically, a side face of the outer lead terminal, and infiltration of moisture and air from outside the electrochemical cell are prevented can be produced. Therefore, the electrochemical cell can maintain a long-term sealing property, thereby advantageously maintaining performance.

In another case, there is provided a method for producing an electrochemical cell in which a power generation element is sealed by an outer packaging laminated film according to the invention comprises the steps of:

forming a sealing material covering portion by melt-bonding the sealing material to an outer lead terminal;

allowing the sealing material to go around a side surface of the outer lead terminal at a temperature of at least a melting point of the sealing material; and

heat-sealing at least one portion of the sealing material covering portion of the outer lead terminal together with the outer packaging laminated film. By performing such method as described above, the electrochemical cell in which leakage of an inner electrolytic solution through a side face of the outer lead terminal, and infiltration of moisture and air from outside the electrochemical cell are prevented can be produced. Therefore, the electrochemical cell can maintain a long-term sealing property, thereby advantageously maintaining performance.

Further, there is provided a constitution in which the sealing material is extruded from the outer packaging laminated film. By taking such constitution, leakage of an inner electrolytic solution from an outer lead terminal, specifically, a side face of the outer lead terminal, and infiltration of moisture and air from outside an electrochemical cell of a thin type are prevented. Therefore, the electrochemical cell of the thin type can maintain a long-term sealing property, thereby advantageously maintaining performance.

Still further, the sealing material is constituted by a modified polyolefin resin. Furthermore, the sealing material is constituted by a laminate constitution comprising a modified polyolefin resin layer, a resin layer having a higher melting point than that of the modified polyolefin resin, and a polyolefin resin layer. Still furthermore, the sealing material is constituted by a laminate constitution comprising a modified polyolefin resin layer, a resin layer having a higher melting point than that of the modified polyolefin resin, and a modified polyolefin resin layer.

By taking such constitution as described above, leakage of an inner electrolytic solution from an outer lead terminal, specifically, a side face of the outer lead terminal, and infiltration of moisture and air from outside an electrochemical cell are prevented. Therefore, the electrochemical cell can maintain a long-term sealing property, thereby advantageously maintaining performance.

According to the invention, there is provided an electrochemical cell in which a power generation element is sealed by an outer packaging laminated film, and in which a sealing material is melt-bonded in an entire periphery of a predetermined portion of an outer lead terminal in which at least a side face is subjected to a surface modification treatment. By taking such constitution as described above, leakage of an inner electrolytic solution from an outer lead terminal, specifically, a side face of the outer lead terminal, and infiltration of moisture and air from outside an electrochemical cell are prevented and, therefore, the electrochemical cell can maintain a long-term sealing property, thereby advantageously maintaining performance. On this occasion, the surface modification treatment is a mechanical surface treatment, a chemical surface treatment, covering or the like.

Further, propylene or a modified polypropylene is provided on an innermost surface of the outer packaging laminated film and the sealing material comprises a layer comprising at least a modified polypropylene. In another aspect, Polyethylene or a modified polyethylene is provided on an innermost surface of the outer packaging laminated film and the sealing material comprises a layer comprising at least a modified polyethylene.

By allowing the resin provided on the innermost surface of the outer packaging laminated film and the sealing material to be a same resin, melt-bonding between them can assuredly be performed. When the sealing material is a three-layered product, by allowing the resin to be melt-bonded to the sealing material and the resin to be provided on the innermost surface of the outer packaging laminated film to be a same resin, melt-bonding between them can assuredly be performed. This feature is very important from the standpoint of sealing the power generation element such as a cell by heat-sealing.

By taking such constitution as described above, leakage of an inner electrolytic solution from an outer lead terminal, specifically, a side face of the outer lead terminal, and infiltration of moisture and air from outside an electrochemical cell are prevented and, therefore, the electrochemical cell can maintain a long-term sealing property, thereby advantageously maintaining performance.

Still further, a method for producing an electrochemical cell in which a power generation element is sealed by an outer packaging laminated film according to the invention comprises the steps of:

Melt-bonding a sealing material to each of front and rear faces of a predetermined portion of an outer lead terminal connected to the power generation element by applying pressure and heat; and

heating in vacuum the power generation element thus treated in the foregoing step. By performing such method as described above, leakage of an inner electrolytic solution from an outer lead terminal, specifically, a side face of the outer lead terminal, and infiltration of moisture and air from outside an electrochemical cell are prevented and, therefore, the electrochemical cell can maintain a long-term sealing property, thereby advantageously maintaining performance.

As described above, according to the invention, since the outer lead terminal in which a side face is completely covered by the sealing material is adopted, at least one portion of the sealing material covering portion of the outer lead terminal is assuredly heat-sealed together with the outer packaging laminated film. Therefore, according to the invention, the electrochemical cell excellent in the sealing property and the long-term reliability can be provided.

### BRIEF DESCRIPTION OF THE DRAWINGS

FIG. 1 is a schematic perspective view of an electrochemical cell of a thin type according to the present invention;

FIG. 2 is a schematic perspective view of a portion of an electrochemical cell of a thin type according to the invention in a state in which a sealing material is provided on front and rear faces of an outer lead terminal;

FIG. 3 is a cross-sectional view of a portion of an electrochemical cell of a thin type according to the invention in a state in which a sealing material is provided on front and rear faces of an outer lead terminal;

FIG. 4 is a cross-sectional view of a portion of an electrochemical cell of a thin type according to the invention in a state in which an outer lead terminal and a sealing material are heated and pressed;

FIG. 5 is a cross-sectional view of a portion of an electrochemical cell of a thin type according to the invention in a state in which a sealing material goes around a side face of an outer lead terminal;

FIG. 6 is a plan view of a portion of an electrochemical cell of a thin type according to the invention in a state in which a sealing material goes around a side face of an outer lead terminal; and

FIG. 7 is a cross-sectional view of an electrochemical cell of a thin type according to the invention.

### DETAILED DESCRIPTION OF THE INVENTION

Hereinafter, an embodiment of an electrochemical cell according to the present invention is now described in detail with reference to the accompanying drawings.

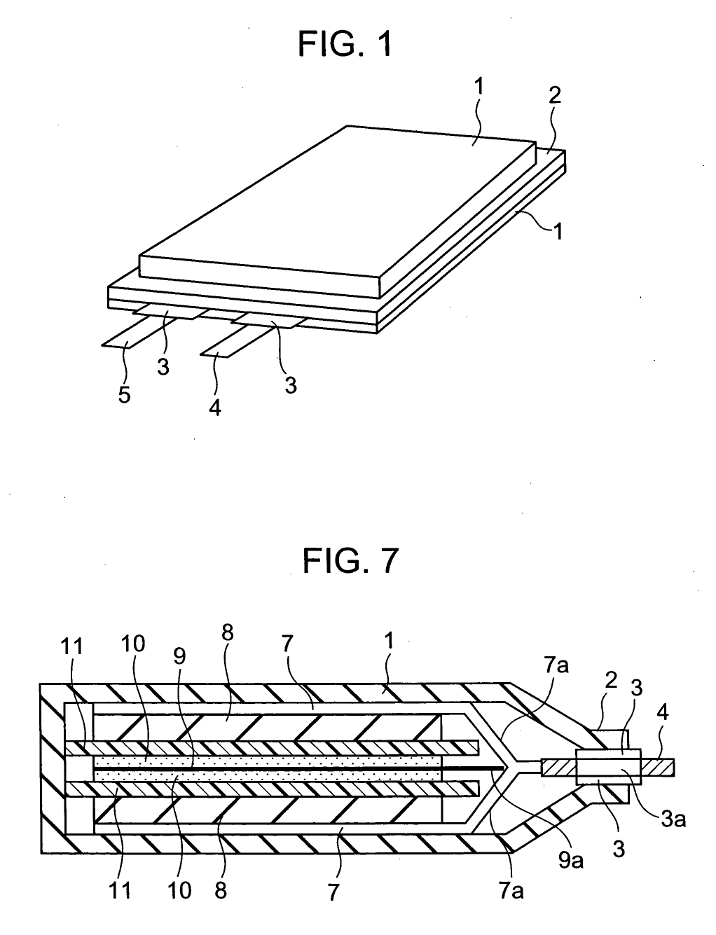

FIG. 1 is a schematic perspective view of an electrochemical cell according to the invention. As shown in FIG. 1, an outer packaging laminated film 1 is sealed in a peripheral portion 2 of the outer packaging laminated film to contain a power generation element. A positive electrode outer lead terminal 4 and a negative electrode outer lead terminal 5 which are connected to the power generation element extend outside the outer packaging laminated film. Further, the positive electrode outer lead terminal 4 and the negative electrode outer lead terminal 5 are each provided with a sealing material 3. A material of the sealing material is preferably same as that of an innermost surface of the outer packaging laminated film 1 (or the peripheral portion 2 of the outer packaging laminated film). In another aspect, even when the former material is not same as the latter material, the former preferably uses a material having a melting point near to that of the latter. By taking such constitution as described above, the outer packaging laminated film and the sealing material are advantageously melt-bonded with each other to enhance a sealing property. Further, it is permissible that the sealing material is of a multi-layer constitution that is a laminated constitution in which a material having a higher melting point than any of surface layers is interposed between the surface layers.

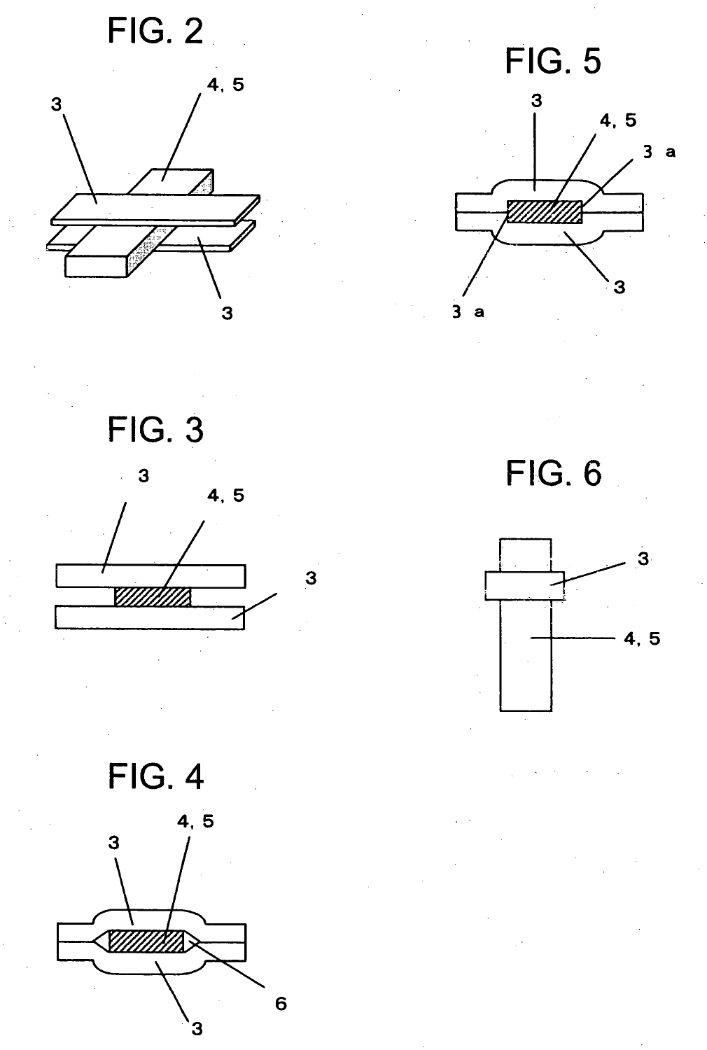

FIG. 2 is a schematic perspective view of a portion of an electrochemical cell according to the invention in a state in which a sealing material is provided on front and rear faces of an outer lead terminal of the positive electrode or the negative electrode. As is shown in FIG. 2, the sealing material 3 is provided on front and rear faces of the positive electrode outer lead terminal 4 or the negative electrode outer lead terminal 5.

FIG. 3 is a cross-sectional view of FIG. 2 and, also, is a cross-sectional view of a portion of an electrochemical cell according to the invention in a state in which a sealing material 3 is provided on front and rear faces of each of outer lead terminals 4 and 5.

FIG. 4 shows a step subsequent to FIG. 3 and is a cross-sectional view of a portion of an electrochemical cell according to the invention in a state in which any one of the outer lead terminals 4 and 5 and a sealing material 3 are heated and pressed by a heat-seal bar. Although the sealing material 3 provided on the front surface and the sealing material 3 on the rear surface of each of the outer lead terminals 4 and 5 are melt-bonded with other, a space 6 still remains between the sealing material 3 and the positive electrode outer lead terminal 4 or the negative electrode lead terminal 5.

FIG. 5 shows a step subsequent to FIG. 4 and is a cross-sectional view of a portion of an electrochemical cell according to the invention in a state in which the sealing material 3 goes around a side face of the positive electrode outer lead terminal 4 or the negative electrode outer lead terminal 5. As is shown in FIG. 5, a portion of the sealing material 3 goes around a side face of each of the outer lead terminals 4 and 5 as a sealing material 3a, thereby allowing the outer lead terminal and the sealing material to contact with each other.

FIG. 6 shows a portion of an electrochemical cell according to the invention and is a plan view in a state in which a sealing material goes around a side face of each of the outer lead terminals 4 and 5.

FIG. 7 is a cross-sectional view of an electrochemical cell according to the invention. In FIG. 7, a constitution of an outer packaging laminated film 1 is polypropylene (thickness: 30 μm)/Al foil (thickness: 40 μm)/nylon (thickness: 25 μm), in which polypropylene becomes an inner surface and nylon becomes an outer surface of the cell. This outer packaging laminated film 1 contains the power generation element and the cell is sealed by heat-sealing the peripheral portion 2 of the outer packaging laminated film. The positive electrode outer lead terminal 4 electrically connects to a positive electrode current collector 7, while the negative electrode outer lead terminal 5 electrically connects to a negative electrode current collector 9. The sealing material 3 covers a portion of each of the positive electrode outer lead terminal 4 and the negative electrode lead terminal 5 in advance. In FIG. 7, although the sealing material 3 separately seals the positive electrode outer lead terminal 4 and the negative electrode outer lead terminal 5 in advance, the sealing material 3 may simultaneously seal the positive electrode outer lead terminal 4 and the negative electrode outer lead terminal 5 in advance. The sealing material 3a goes around the side face of the positive electrode outer lead terminal 4 or the negative electrode outer lead terminal 5. The positive electrode current collector 7 comprising an aluminum foil is coated with a positive electrode layer 8. The negative electrode current collector 9 comprising a copper foil is coated on both surfaces with a negative electrode layer 10. A separator 11 comprising polyethylene or polypropylene is provided between the positive electrode layer 8 and the negative electrode layer 10. A positive electrode inner terminal 7a in strip form is connected to the positive electrode current collector 7, while a negative electrode inner terminal 9a in strip form is connected to the negative electrode current collector 9. The positive electrode outer lead terminal 4 comprising aluminum is welded with the positive electrode inner terminal 7a and they are electrically connected to each other. This positive electrode outer lead terminal 4 extends from the outer packaging laminated film 1 to the outside of the cell. The negative electrode outer lead terminal 5 comprising copper is welded to the negative electrode inner terminal 9a and they are electrically connected to each other. This negative electrode outer lead terminal 5 extends from the outer packaging laminated film 1 to the outside of the cell. Further, the sealing material 3 is extruded from the peripheral portion 2 of the outer packaging laminated film 1. The electrolytic solution is a mixed solution of ethylene carbonate (EC) containing 1 mol/l of LIPF₆, and dimethyl carbonate (MEC). The power generation element is constituted by the positive electrode current collector 7, the positive electrode layer 8, the negative electrode current collector 9, the negative electrode layer 10, the separator 11, the positive electrode inner terminal 7a, and the negative electrode inner terminal 9a.

Next, taking as a sample a polymer lithium secondary cell which is an embodiment according to the invention, fundamental constitutional materials thereof are described. As for positive electrode active materials, various types of oxides (for example, a lithium-manganese complex oxide such as LiMn₂O₄, manganese dioxide, nickel oxide containing lithium such as LiNiO₂, cobalt oxide containing lithium such as LiCoO₂₁ nickel-cobalt oxide containing lithium, and amorphous vanadium pentoxide containing lithium), chalcogen compounds (for example, titanium disulfide, and molybdenum disulfide) and the like can be used. Among them, the lithium-manganese complex oxide, cobalt oxide containing lithium, and nickel oxide containing lithium can be used. These positive electrode active materials are applied to an aluminum foil which is a current collector.

As for negative electrode active materials, a carbonaceous material which can absorb and discharge a lithium ion can be used. Examples of such carbonaceous materials to be usable include a product obtained by sintering an organic polymer compound (for example, a phenol resin, polyacrylonitrile, or cellulose), a product obtained by sintering cokes, or mesophase pitch, other carbonaceous materials represented by artificial graphite, natural graphite and the like. Among them, the carbonaceous material obtained by sintering the mesophase pitch in an atmosphere of an inert gas such as an argon gas or a nitrogen gas at a temperature of from 500° C. to 3000° C. under normal pressure or reduced pressure can be used. This negative electrode active material is applied to the copper foil which is a current collector.

The non-aqueous electrolytic solution can be prepared by dissolving an electrolyte in a non-aqueous solvent. Examples of such non-aqueous solvents to be usable include ethylene carbonate (EC), propylene carbonate (PC), butylene carbonate (BC), dimethyl carbonate (DMC), diethyl carbonate (DEC), ethyl methyl carbonate (EMC), γ-butyrolactone (γ-BL), sulforane, acetonirile, 1,2-dimethoxyethane, 1,3-dimethoxypropane, dimethyl ether, tetrahydrofuran (THF), and 2-methyltetrahydrofuran. These non-aqueous solvents may be used either each individually or in any combinations thereof.

Examples of such electrolytes to be usable include lithium salts such as lithium perchlorate, (LiClO₄), lithium hexafluorophosphate (LIPF₆), tetrafluoroborolithium (LiBF₄), hexafluoroarsenolithium (LiAsF₆), and lithium trifluoromethane sulfonate (LiCF₃SO₃).

Examples of usable polymers which polymerize the electrolyte include a polyethylene oxide derivative, a polypropylene oxide derivative, a polymer containing any one of the aforementioned derivatives, polytetrafluoropropylene, the copooymer between vinylidene fluoride (VdF) and hexafluoropropylene (HFP), and polyvinylidene fluoride (PVdF). Among them, a copooymer between vinylidene fluoride (VdF) and hexafluoropropylene (HFP) is preferable. As for such separators, a porous separator comprising polyethylene or polypropylene can be used.

Examples of the outer packaging laminated films to be usable include a laminated film of modified polypropylene (PP)/polyethylene terephthalate (PET)/Al foil/PET, laminated films of modified polyethylene (PE)/nylon/Al foil/PET, modified PP/Al foil/nylon, modified PE/Al foil/nylon, PE/Al foil/nylon, PP/Al foil/nylon, modified PP/Al foil/PET/nylon, and modified PE/Al foil/PET/nylon

### EXAMPLES

Hereinafter, embodiments according to the present invention will be described in detail.

### Example 1

As shown in FIGS. 2 and 3, a sealing material 3 comprising a modified polypropylene (melting point: 135° C.) having a thickness of 30 μm is provided on a predetermined portion of each of a positive electrode outer lead terminal 4 and a negative electrode outer lead terminal 5 and, further, front and rear surfaces of each of the outer lead terminals. Since the outer lead terminals are each comprising copper, nickel, or aluminum in strip form, polyethylene or polypropylene, unless modified by acrylic acid or maleic acid, is not melt-bonded to the outer lead terminal. Selection of the modified polyethylene or the modified polypropylene as the sealing material 3 can be performed on the basis of a temperature at which an electrochemical cell of a thin type is used. When the temperature at which the electrochemical cell is used is high, the modified polypropylene having a high melting point is preferably used. As shown in FIG. 4, the sealing material 3 provided on the front and rear faces of each of the positive electrode outer lead terminal 4 and negative electrode outer lead terminal 5 was applied with heat and pressure from top and bottom by a heat-seal bar under conditions of 190° C., 2.0 MPa, and 3 seconds. The outer lead terminals can use, for example, copper, nickel, aluminum or stainless steel in strip form. On this stage, a space 6 can still be noticed on a side face of each of the outer lead terminals. The outer lead terminals which were each melt-bonded with the sealing material 3 were placed in a vacuum-drying box having a degree of vacuum of 10⁻² Torr or more and, then, heated for 30 minutes at 200° C. On this stage, as shown in FIG. 5, a sealing material 3a which went around a side face of the outer lead terminal is in a state of being completely melt-bonded with each of the outer lead terminals. The side face of the outer lead terminal and the sealing material 3a are bonded with each other by a van der Waals force on an interface therebetween and, accordingly, leakage of an electrolytic solution inside the electrochemical cell of the thin type or infiltration of moisture and air from outside the electrochemical cell of the thin type can be prevented. The positive electrode lead terminal 4 in which an entire periphery is melt-bonded with the sealing material 3 is welded by ultrasonic wave to a positive electrode inner terminal 7a in strip form that is electrically connected to the power generation element, while the negative electrode lead terminal 5 in which an entire periphery is melt-bonded with the sealing material 3 is welded by ultrasonic wave to a negative electrode inner terminal 9a in strip form that is electrically connected to the power generation element. The outer packaging laminated film 1 contains the power generation element and seals the electrochemical cell of the thin type by heat-sealing the peripheral portion 2 thereof together with the outer lead terminals 4 and 5 which have each been melt-bonded with the sealing material 3 on the entire periphery thereof. Since an innermost surface of the outer packaging laminated film 1 comprises polypropylene or the modified polypropylene and is the same material as that of the sealing material 3, the outer packaging laminated film 1 performs an excellent bonding. A metal layer is exposed at a cross-section of the periphery of the outer packaging laminated film 1. There is a risk of forming a short-circuit between the outer lead terminals 4 and 5 by folding the outer lead terminals 4 and 5 and to allow the thus-folded outer lead terminals 4 and 5 to contact with the metal layer of the outer packaging laminated film 1. According to the invention, the sealing material 3 is extruded by about 0.5 mm from the periphery of the outer packaging laminated film 1. A given volume of such extrusion is sufficient so far as it is longer than a thickness of from 0.09 to 0.12 mm of the outer packaging laminated film 1. By providing this given volume of the extrusion, the positive electrode outer lead terminal 4 and the negative electrode outer lead terminal 5 are prevented from forming the short-circuit via the metal layer of the outer packaging laminated film 1. When 100 units of lithium ion secondary cell having a size of 40 mm×62 mm×3 mm were prepared in accordance with the present embodiment and, then, stored at relative humidity 90% and a temperature of 60° C. for 40 days, there was no leakage at all at the positions of the outer lead terminals 4 and 5.

### Example 2

As shown in FIGS. 2 and 3, a sealing material 3 comprising a three-layered product of modified polypropylene (melting point: 135° C.; thickness: 25 μm)/polymethylpentene (melting point: 225° C.; thickness 50 μm)/modified polypropylene (melting point: 135° C.; thickness: 25 μm) was provided on a predetermined portion of each of outer lead terminals 4 and 5, or front and rear faces of the outer lead terminal. Further, although another three-layered product of modified polypropylene (melting point: 135° C.; thickness: 25 μm)/polymethylpentene (melting point: 225° C.; thickness: 50 μm)/polypropylene (melting point: 135° C.; thickness: 25 μm) is also usable as the sealing material 3, it is difficult to distinguish the front surface from the rear surface and, therefore, it is required to pay a careful attention when it is used. As shown in FIG. 4, the sealing material 3 which has been provided on the front and rear faces of each of the outer lead terminals 4 and 5 was applied with heat and pressure from top and bottom by a heat-seal bar under conditions of 190° C., 2.0 MPa, and 3 seconds. On this stage, a space 6 can be noticed on a side face of each of the outer lead terminals 4 and 5. The outer lead terminals which were each melt-bonded with the sealing material 3 were placed in a vacuum-drying box having a degree of vacuum of 10⁻² Torr or more and, then, heated for 30 minutes at 200° C. On this stage, as shown in FIG. 5, a sealing material 3a which went around the side face of each of the outer lead terminals 4 and 5 is in a state of being completely melt-bonded with each of the outer lead terminals. When 100 units of polymer secondary cell having a size of 40 mm×62 mm×3 mm were prepared in accordance with the present embodiment and, then, examined as to whether a short-circuit was formed between the outer lead terminals 4 and 5. As a result, the short-circuit was not formed at all. The reason is that polymethylpentene having a high melting point was adopted in an interposed state. Namely, even when polypropylene of the innermost surface of the outer packaging laminated film 1 and polypropylene of the sealing material 3 are melt-bonded with each other, a phenomenon in which any one of the outer lead terminals 4 and 5 contacts with an Al foil inside the outer packaging laminated film and forms a electric short-circuit therebetween does not occur.

### Example 3

As shown in FIGS. 2 and 3, a sealing material 3 comprising a three-layered product of modified polypropylene (melting point: 135° C.; thickness: 30 μm)/polyethylene naphthalate (melting point: from 260° C. to 270° C.; thickness: 12 μm)/modified polypropylene (melting point: 135° C.; thickness: 30 μm) was provided on a predetermined portion of each of outer lead terminals 4 and 5, or front and rear faces of the outer lead terminal. As shown in FIG. 4, the sealing material 3 provided on the front and rear faces of each of the positive electrode outer lead terminal 4 and the negative electrode outer lead terminal 5 was applied with heat and pressure from top and bottom by a heat-seal bar under conditions of 190° C., 2.0 MPa, and 3 seconds. On this stage, a space 6 can be noticed on a side face of each of the outer lead terminals 4 and 5. The outer lead terminals 4 and 5 which were each melt-bonded with the sealing material 3 were placed in a vacuum-drying box having a degree of vacuum of 10⁻² Torr or more and, then, heated for 30 minutes at 200° C. On this stage, as shown in FIG. 5, a sealing material 3a which went around a side face of each of the outer lead terminals 4 and 5 is in a state of being completely melt-bonded with each of the outer lead terminals 4 and 5. When 100 units of double-layered electric capacitors each having a size of 40 mm×62 mm×3 mm were prepared in accordance with the present embodiment and, then, examined as to whether a short-circuit was formed between the outer lead terminals 4 and 5. As a result, the short-circuit was not formed at all. The reason is that polyethylene naphthalare having a high melting point was adopted in an interposed state. Namely, even when polypropylene of the innermost surface of the outer packaging laminated film 1 and polypropylene of the sealing material 3 are melt-bonded with each other, a phenomenon in which any one of the outer lead terminals 4 and 5 contacts with an Al foil inside the outer packaging laminated film and forms a electric short-circuit therebetween does not occur.

### Example 4

According to the invention, there is provided an electrochemical cell of a thin type in which a sealing material is melt-bonded in an entire periphery of a predetermined portion of an outer lead terminal at least a side face of which is subjected to a surface modification treatment. For example, the outer lead terminal comprising aluminum in strip form having a width of 4 mm and a thickness of 0.08 mm is, after a pretreatment step comprising degreasing, etching, and the like, subjected to a substrate treatment. As for the degreasing, alkalescent degreasing, emulsion degreasing, solvent degreasing or the like is adopted. As for the etching, alkali or acid etching is adopted. As for the substrate treatment, an anodic oxide film treatment or a chemical film treatment (chemical treatment) is adopted. On this occasion, as the chemical film treatment, chromium phosphate film treatment method is adopted, in which an outer lead terminal comprising aluminum is dipped in a treatment solution containing chromic acid, phosphoric acid, and a fluoride to be treated at from 20° C. to 50° C. for from 30 seconds to 7 minutes. By such treatment as described above, films of aluminum phosphate and chromium phosphate are formed on both a surface and a side face of aluminum and, a modified polypropylene of a sealing material 3 is melt-bonded with the films on both the surface and the side face of aluminum, and maleic acid or acrylic acid in the modified polypropylene intensively acts on each of the films to form strong bonding therebetween. As for the substrate treatment, the anodic oxide film treatment can also be adopted. The outer lead terminal comprising aluminum was treated in an electrolytic solution of sulfuric acid for 10 minutes at 20° C. with an electric current density of 300 A/m² and a voltage of 16V to form a porous oxide film having a thickness of about 3 μm thereon. By this arrangement, a porous oxide film of aluminum was formed on a surface and a side face of aluminum and, then, the modified polypropylene of the sealing material 3 was melt-bonded with each of the surface and the side face of aluminum to form strong bonding therebetween. A mechanism of such strong bonding is assumed to be that melt-bonded modified polypropylene is infiltrated into pores of the porous oxide film of aluminum and that the oxide film, and maleic acid or acrylic acid in the modified polypropylene strongly acts on each other to form strong bonding. Namely, bonding is formed by a van del Waals force not only at an interface between each of the outer lead terminals 4 and 5 and the sealing material 3, but also at an interface between the side face of each of the outer lead terminals 4 and 5 and the sealing material 3a and, accordingly, leakage of the electrolytic solution inside the cell or infiltration of moisture and air from outside the cell can be prevented.

### Example 5

Based on FIG. 7, a method for producing an electrochemical cell of a thin type according to the invention in which a power generation element is sealed by an outer packaging laminated film is described below. A positive electrode outer lead terminal 4, and a negative electrode outer lead terminal 5 are connected to the power generation element comprising a positive electrode current collector 7, a positive electrode layer 8, a negative electrode current collector 9, a negative electrode layer 10, and a separator 11 via a positive electrode inner terminal 7a in strip form and a negative electrode inner terminal 9a each in strip form, respectively. The positive inner terminal 7a in strip form is welded to the positive electrode lead terminal 4 by resistance welding, ultrasonic welding, laser welding or the like, while the negative inner terminal 9a in strip form is welded to the negative electrode lead terminal 5 by resistance welding, ultrasonic welding, laser welding or the like. On this occasion, the power generation element which is attached with the positive electrode lead terminal 4 and the negative electrode lead terminal 5 is hereinafter referred to as a power generation element body. The sealing material 3 is melt-bonded to a predetermined position of each of the positive electrode outer lead terminal 4 and the negative electrode outer lead terminal 5 with heat and pressure from top and bottom by a heat-seal bar under conditions of 190° C., 2.0 MPa, and 3 seconds. On this stage, the power generation body is in a state as shown in FIG. 4. Further, this power generation element body is placed in a vacuum-drying box having a degree of vacuum of 10⁻² Torr or more for the purpose of removing a contained moisture and, then, heated for 16 hours at 200° C. In a dried stage of the power generation element body, as shown in FIG. 5, a sealing material 3a which went around a side face of each of the outer lead terminals 4 and 5 is in a state of being completely melt-bonded with each of the outer lead terminals 4 and 5. Namely, according to the present embodiment, it is possible to simultaneously perform a step of drying the power generation element body and a step of melt-bonding each of the outer lead terminals 4 and 5 with the sealing material 3 and, accordingly, production steps can be rationalized. By taking such constitution as described above, since leakage of an inner electrolytic solution from an outer lead terminal, specifically, a side face of the outer lead terminal, and infiltration of moisture and air from outside the electrochemical cell of the thin type are prevented and, therefore, the electrochemical cell of the thin type can maintain a long-term sealing property, thereby advantageously maintaining performance. According to the present embodiment, since the outer lead terminal in which the side face is completely covered by the sealing material is adopted, at least a portion of a sealing material covering portion of the outer lead terminal is assuredly heat-sealed together with the outer packaging laminated film. Therefore, according to the present embodiment, there can be provided the electrochemical cell of the thin type which is excellent in the sealing property and the long-term reliability.

### Comparative Example 1

As shown in FIG. 4, the sealing material 3 provided on front and rear faces of each of the outer lead terminals 4 and 5 was applied with heat and pressure from top and bottom under conditions of 190° C., 2.0 MPa, and 3 seconds as in Example 1, but subsequent treatments were not performed.

### Comparative Example 2

The outer lead terminal comprising aluminum in strip form having a width of 4 mm, and a thickness of 0.08 mm was subjected only to degreasing, as in Example 4.

From Examples 1 and 4 according to the present invention and Comparative Examples 1 and 2, 100 units of lithium ion secondary cell each having a size of 40 mm×62 mm×33 mm were prepared, respectively, stored at relative humidity of 90%, a temperature of 60° C. for 40 days and, then, examined of leakage thereof at the outer lead terminal portion. As a result, in the lithium ion secondary cell applying the present invention, leakage of a solution at the outer lead terminal portion was not generated at all. On the other hand, in the lithium ion secondary cell applying Comparative Example 1, the leakage of the solution at the outer lead terminal portion was generated at a rate of 30%. Further, in the lithium ion secondary cell applying Comparative Example 2, the leakage of the solution at the outer lead terminal portion was generated at a rate of 10%.

As described above in detail, according to the invention, an electrochemical cell excellent in a sealing property and a long-term reliability can be provided. Application of the present invention to a lithium ion secondary cell, a polymer lithium secondary cell, or a double-layered electric capacitor is markedly effective. Application of the present invention not only to a secondary cell but also to a primary cell is markedly effective.

What is claimed is:

1. An electrochemical cell in which a power generation element is sealed by an outer packaging laminated film, wherein a sealing material is melt-bonded in an entire periphery of a predetermined portion of an outer lead terminal.

2. An electrochemical cell as set forth in claim 1;
wherein the sealing material is extruded from the outer packaging laminated film.

3. An electrochemical cell as set forth in claim 1;
wherein the sealing material is a modified polyolefin resin.

4. An electrochemical cell as set forth in claim 1;
wherein the sealing material is a laminate structure comprising a modified polyolefin resin layer, a resin layer having a higher melting point than that of the modified polyolefin resin, and a polyolefin resin layer.

5. An electrochemical cell as set forth in claim 1;
wherein the sealing material is a laminate structure comprising a modified polyolefin resin layer, a resin layer having a higher melting point than that of the modified polyolefin resin, and a modified polyolefin resin layer.

6. An electrochemical cell as set forth in claim 1;
wherein a side face of an outer lead terminal to which the sealing material is melt-bonded is subjected to a surface modification treatment.

7. An electrochemical cell as set forth in claim 6; wherein the surface modification treatment is a mechanical surface treatment, a chemical surface treatment or covering.

8. An electrochemical cell as set forth in claim 1;
wherein propylene or a modified polypropylene is provided on an innermost surface of the outer packaging laminated film and the sealing material comprises a layer comprising at least a modified polypropylene.

9. An electrochemical cell as set forth in claim 1;
wherein polyethylene or a modified polyethylene is provided on an innermost surface of the outer packaging laminated film and the sealing material comprises a layer comprising at least a modified polyethylene.

10. An electrochemical cell in which a power generation element is sealed by an outer packaging laminated film, wherein a sealing material is melt-bonded to an outer lead terminal and the sealing material goes around a side face of the outer lead terminal.

11. An electrochemical cell as set forth in claim 10;
wherein the sealing material is extruded from the outer packaging laminated film.

12. An electrochemical cell as set forth in claim 10;
wherein the sealing material is a modified polyolefin resin.

13. An electrochemical cell as set forth in claim 10;
wherein the sealing material is a laminate structure comprising a modified polyolefin resin layer, a resin layer having a higher melting point than that of the modified polyolefin resin, and a polyolefin resin layer.

14. An electrochemical cell as set forth in claim 10;
wherein the sealing material is a laminate structure comprising a modified polyolefin resin layer, a resin layer having a higher melting point than that of the modified polyolefin resin, and a modified polyolefin resin layer.

15. An electrochemical cell as set forth in claim 10;
wherein a side face of an outer lead terminal to which the sealing material is melt-bonded is subjected to a surface modification treatment.

16. An electrochemical cell as set forth in claim 15; wherein the surface modification treatment is a mechanical surface treatment, a chemical surface treatment or covering.

17. An electrochemical cell as set forth in claim 10;
wherein propylene or a modified polypropylene is provided on an innermost surface of the outer packaging laminated film and the sealing material comprises a layer comprising at least a modified polypropylene.

18. An electrochemical cell as set forth in claim 10;
wherein polyethylene or a modified polyethylene is provided on an innermost surface of the outer packaging laminated film and the sealing material comprises a layer comprising at least a modified polyethylene.

19. A method for producing an electrochemical cell in which a power generation element is sealed by an outer packaging laminated film, comprising the steps of:
forming a sealing material covering portion by melt-bonding the sealing material in an entire periphery of a predetermined portion of an outer lead terminal; and
heat-sealing at least one portion of the sealing material covering portion of the outer lead terminal together with the outer packaging laminated film.

20. A method for producing an electrochemical cell in which a power generation element is sealed by an outer packaging laminated film, comprising the steps of:
forming a sealing material covering portion by melt-bonding the sealing material to an outer lead terminal;
allowing the sealing material to go around a side surface of the outer lead terminal at a temperature of at least a melting point of the sealing material; and
heat-sealing at least one portion of the sealing material covering portion of the outer lead terminal together with the outer packaging laminated film.

21. A method for producing an electrochemical cell in which a power generation element is sealed by an outer packaging laminated film, comprising the steps of:
melt-bonding a sealing material to each of front and rear faces of a predetermined portion of an outer lead terminal connected to the power generation element by applying pressure and heat; and
heating in a vacuum the power generation element thus treated in the foregoing step.
